(19) United States
(12) Patent Application Publication
(10) Pub. No.: US 2013/0097277 A1
(43) Pub. Date: Apr. 18, 2013

(54) METHOD AND APPARATUS FOR LOAD BALANCING OF CONTENT-CENTRIC NETWORK

(71) Applicant: Electronics and Telecommunications Research In, Daejeon (KR)

(72) Inventor: Tae-Yeon KIM, Daejeon-si (KR)

(73) Assignee: Electronics and Telecommunications Research Institute, Daejeon (KR)

(21) Appl. No.: 13/650,213

(22) Filed: Oct. 12, 2012

(30) Foreign Application Priority Data
Oct. 12, 2011 (KR) 10-2011-0104239
Jun. 18, 2012 (KR) 10-2012-0065197

(51) Int. Cl. G06F 15/16

(52) U.S. Cl. 709/217

(57) ABSTRACT

An apparatus and a method for load balancing of a content-centric network for optimally delivering content requested by a user are provided. The apparatus includes two or more subnet managing units divided according to physical distance or service providers and a content network managing unit configured to manage and connect subnets. In addition, the method includes searching for two or more subnets containing content; in response to two or more subnets being found according to the search result, selecting a subnet delivering a requested content from among the two or more found subnets according to a network state and selecting nodes included in the subnet; and delivering the content. Accordingly, an optimal server node is selected on the network in the middle of content delivery from a content server to the user so that traffic efficiency may be enhanced and a higher-quality real-time streaming service may be provided.

### CROSS-REFERENCE TO RELATED APPLICATION

This application claims the benefit under 35 U.S.C. §119(a) of Korean Patent Application Nos. 10-2011-0104239, filed on Oct. 12, 2011, and 10-2012-0065197, filed on Jun. 18, 2012, the entire disclosures of which are incorporated herein by references for all purposes.

### BACKGROUND

1. Field

The following description relates to load balancing of network for delivering content.

2. Description of the Related Art

The wide spread of IPTV services, smart TVs and smart phones rapidly increases the number of Internet content services, resulting in an increase in network traffic. In addition, while networks were largely used for telecommunications, Internet services and other general communication services in the past, they are recently being used for a Video on Demand (VOD), a real-time broadcast and a mass storage file, causing much heavier network traffic. In particular, increasing demands for video content services with high definition and mass storage add more load to networks.

In order to address a structural problem of a network which triggers network traffic congestion, a Content Delivery Network (CDN) allocates a plurality of servers to the edge of network according to network providers or local areas, and distributes content concentrated on existing content servers to servers of each network provider by duplicating the content, thereby ensuring content delivery quality for a user.

As described above, the role of Global Server Load Balancing (GSLB) techniques in the CDN service is to balance traffic load on the content servers, which are distributed according to the network providers or the local areas, and to select a server providing optimal traffic with reference to the location of a user requesting content or the state of the current content server.

GSLB techniques have been introduced for replication of a computing center or a data center such as a financial computing network or as one of the major configurations of a disaster recovery center so as to minimize damages from an unexpected disaster. Recently, GSLB techniques are used as a service of data centers to select a server, which provides corporate service users with business application servers arranged in data centers or disaster recovery centers which are located at different areas respectively. The major function of GLSB techniques is to collect information about service state or service performance in association with functions of an intelligent Domain Name system (DNS) server to thereby provide a connection to an optimal server.

Related arts provide numerous methods for, in response to a user's request for a predetermined content or service on a CDN, accessing a content service network using a DNS, connecting a valid web server on the content service network, selecting an optimal CDN server based on user location and delivering a service to a user's client terminal using HTTP redirection techniques. The amount of content and the number of content types are increasing at an unprecedented rate; however, the CDN is structurally difficult to be extended so that the existing optimization method may have a limitation and at least three problems.

First, the existing method for allocating content servers to a predetermined section of a network behind a POP section of network and distributing the content servers to a user may ultimately add more load to the predetermined section of the network which the content servers are allocated to or content of the content servers passes so that it may be hard to continuously respond to a user's need for high-quality services. In addition, although a CDN may be used as a section of the network between a user and a content server, it would be difficult to efficiently manage bandwidth in a section having a redundant traffic flow.

Second, as real-time broadcast and video service have become popular, a streaming service is required to be efficiently processed on a content network. The existing method is available to bring content to a network adjacent to a service user for the purpose of quick connection and to stream the content on request in the case of on-demand services such as Video-on-demand (VOD) whereas content cannot be brought to a network in advance in the case of a real-time TV due to service characteristics. In other words, even in a case where a cache function is used, a real-time streaming service cannot be provided efficiently so that a bandwidth may be wasted.

Third, when delivering content located at a different area or an area of a different service provider, a user location-based service such as a CDN is unavailable due to local differences or differences in service providers, and, even though a previously-provided content is requested again, there is no choice but to deliver the content at a distance using the same method as used before. Hence, there is a structural problem that the CDN cannot be used for content services of different local areas or different service providers.

### SUMMARY

The following description relates to delivering a method and an apparatus for load balancing of network for selecting a server node to optimally deliver content requested by a user to thereby provide a user with the best content service using optimal network resources.

The apparatus for load balancing of a content-centric network according to the present invention includes a content network managing unit configured to store a plurality of content, to select a node capable of delivering requested content in response to a content request from a connected user, to deliver the requested content to a user using the selected node, to select, store and manage subnets, which are divided into two or more according to physical distance or service providers, and information about the two or more divided subnets and to select a subnet delivering the content from among the subnet divided into two or more in consideration of a network state so as to connect the subnet divided into two or more.

The method for load balancing of a content-centric network according to the present invention includes searching for two or more subnets containing content requested by a content request from a user, in response to the two or more subnets, selecting one subnet delivering the requested content from among the two or more subnets according to a network state, selecting a node delivering the requested content from among a plurality of nodes included in the selected subnet according to the network state and delivering the content by setting a session connection between the selected subnet and a subnet accessed by the user.

### BRIEF DESCRIPTION OF THE DRAWINGS

FIG. 1 is a diagram illustrating a configuration of an apparatus for load balancing of a content-centric network according to an exemplary embodiment of the present invention.

FIG. 2 is a diagram illustrating in detail a network managing unit 100 of the apparatus of FIG. 1.

FIG. 3 is a diagram illustrating in detail a Content Network Load Balancing (CNLB) unit 140 of the network managing unit of the apparatus for load balancing of a content-centric network according to an exemplary embodiment of the present invention.

FIG. 4 is a diagram illustrating a configuration of a subnet 300 of the apparatus for load balancing of a content-centric network according to an exemplary embodiment of the present invention.

FIG. 5 is a diagram illustrating in detail a subnet managing unit 200 of the apparatus according to an exemplary embodiment of the present invention.

FIG. 6 is a diagram illustrating in detail a content subnet load balancing (CSLB) unit 210 of the subnet managing unit 200 of FIG. 5.

FIG. 7 is a flowchart illustrating a method for load balancing of a content-centric network to an exemplary embodiment of the present invention.

FIG. 8 is a flowchart illustrating a method for selecting a subnet in the method for load balancing of a content-centric network according to an exemplary embodiment of the present invention.

FIG. 9 is a flowchart illustrating a method for selecting a server node in the method for load balancing of a content-centric network according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is delivered to assist the reader in gaining a comprehensive understanding of the methods, apparatuses, and/or systems described herein. Accordingly, various changes, modifications, and equivalents of the methods, apparatuses, and/or systems described herein will be understood by those of ordinary skill in the art. Also, descriptions of well-known functions and constructions may be omitted for increased clarity and conciseness.

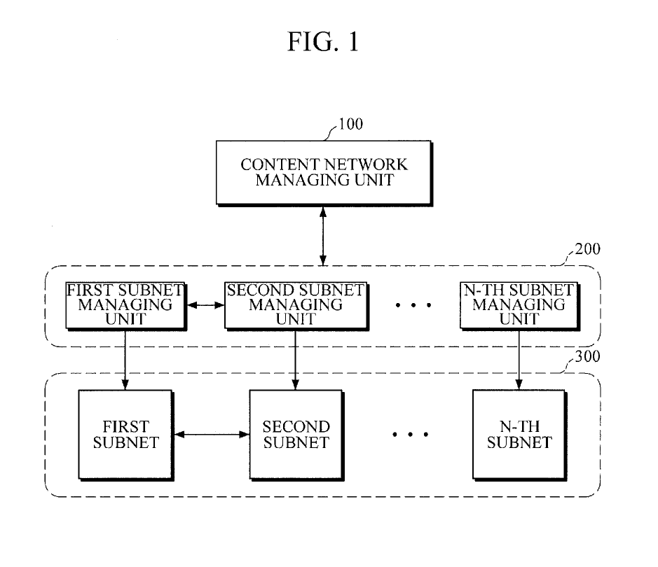

FIG. 1 is a diagram illustrating a configuration of an apparatus for load balancing of a content-centric network according to an exemplary embodiment of the present invention.

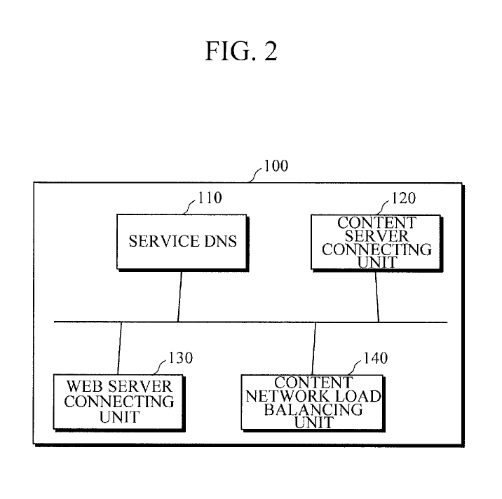

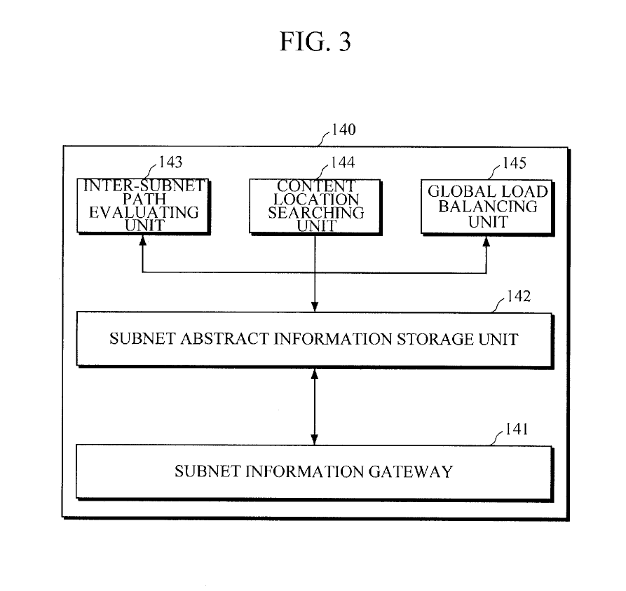

Referring to FIG. 1, the apparatus for load balancing of a content-centric network according to an exemplary embodiment of the present invention includes a network managing unit 100 and two or more subnet managing units 200. The network managing unit 100 divides a network into two or more subnets 300 according to areas or service providers. The network managing unit 100 manages the two or more subnet managing units 200, searches for a subnet containing content requested by a user from among the two or more subnets 300 at a user's request, searches for an optimal subnet 300 capable of most efficiently delivering the content among the subnets 300 containing the content, delivers the search result to a subnet managing unit 200 connected to the found subnet 300, and connects between the user subnet 300 currently being accessed by the user and the subnet 300 delivering the content. Configuration and explanation about the network managing unit 100 will be delivered in detail with reference to FIGS. 2 and 3.

The two or more subnet managing units 200 are respectively connected to each of the subnets 300 to manage and control the corresponding subnets 300. In addition, the two or more subnet managing units 200 collect load information, traffic information and stored content information about the connected subnets 300 to be stored. The two or more subnets 300 are configured by dividing an entire network into two or more subnets according to local areas or service providers and each subnet is controlled by each of the subnet managing units 200. A plurality of nodes composing one subnet 300 store different content respectively without redundancy. If networks of all areas or all service providers are combined into one network in order to prevent a redundancy of content, instead of dividing the entire network into the two or more subnets 300, redundant storage of content may be prevented but it may be more difficult to control and manage the entire network. In addition, if the two or more subnets 300 are divided and controlled according to areas or service providers, each of the subnets 300 may deliver a distinctive service, thereby enabling delivery of higher-quality content for a user. Hence, dividing the entire network into the two or more subnets 300 to be controlled may be desirable. In other words, the same subnet 300 does not have redundant content and different subnets 300 may have redundant content.

The two or more subnet managing units 200 may configure a plurality of nodes to respectively store content without redundancy, connect each of the two or more subnets 300 to deliver and receive the content, search for the content stored in the nodes composing the subnets 300 and directly deliver the found content for a user. In addition, the subnet managing units 200 may deliver the content to the user by searching for not only the content stored in the subnet node but also that currently being delivered or temporarily stored in a middle node of a network. Hence, the subnet nodes composing the subnets 300 include a content server node configured to store content, a transit node configured to provide a network function and a cache node configured to temporarily store the content. Those subnets are connected to each other through the network in any connection form, and there may be one or more access nodes between the subnets 300. A user who wishes to receive a content service is connected to any one of two or more subnets 300, and each of the subnets 300 may configure an independent subscriber network.

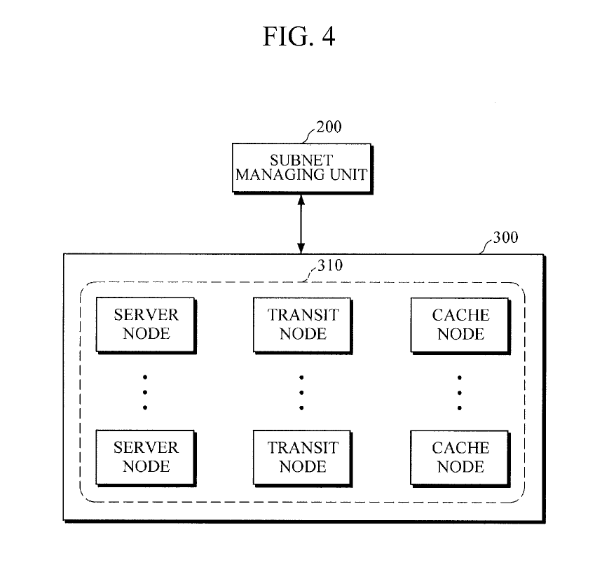

Configurations and explanations about the subnet managing unit 200 will be delivered in detail with reference to FIG. 4.

FIG. 2 is a detailed drawing illustrating the network managing unit 100 of the apparatus for load balancing of a content-centric network according to an exemplary embodiment of the present invention.

Referring to FIGS. 1 and 2, the network managing unit 100 includes a service DNS 110, a content server connecting unit 120, a web server connecting unit 130 and a Content Network Load Balancing (CNLB) unit 140.

The content server connecting unit 120 connects between the subnet 300 accessed by a user access to request content and another subnet 300 delivering the corresponding content out of two or more subnets 300. In order to search for a desired web or content, the service DNS 110 searches for a service Internet Protocol (IP) in association with a local DNS. In addition, the web server connecting unit 130 delivers a web interface of a user terminal.

In response to the content request from the user, the CNLB unit 140 searches for the subnet containing the requested content using content information stored in the two or more subnet managing units 200 and selects one of the subnet managing units 200 capable of most efficiently delivering the corresponding content. At this time, a method for most efficiently delivering content is chosen in consideration of a physically-adjacent network, a communication network state and the load degree of each of the subnets 300.

FIG. 3 is a detailed drawing illustrating the CNLB unit 140 of the network managing unit of the apparatus for load balancing of a content-centric network according to an exemplary embodiment of the present invention.

Referring to FIGS. 1 and 3, the CNLB unit 140 of the network managing unit according to an exemplary embodiment of the present invention includes a Subnet Information Gateway (SIG) 141, a subnet abstract information storage unit 142, an inter-subnet path evaluating unit 143, a content location searching unit 144 and a global load balancing unit 145.

The SIG 141 is connected to the two or more subnet managing units 200 included in the apparatus for load balancing of a content-centric network so as to collect abstract information from each of the subnet managing units 200.

The subnet abstract information storage unit 142 stores the abstract information collected by the SIG 141 from each of the subnet managing units 200. The abstract information may be the minimum information required for searching for the subnet 300 capable of delivering the content, rather than the entire information about each node and network. That is, the abstract information may be information about content stored in each of the subnets 300 and state information about each of the subnets. Storing and managing only abstract information instead of detailed information are to enhance efficiency in network management by using the abstract information as hierarchical information a network. The global load balancing unit 145 adjusts the load of each subnet using the stored subnet load information.

TABLE 1

| | | | |
|---|---|---|---|
| Subnet ID | Subnet State | Subnet Traffic | Subnet Content |
| | Information | Information | Information |

An example of abstract information delivered from the subnet managing unit 200 to be stored in the content network load balancing module 140 is as below.

Referring to Table 1, each of the subnets 300 is given an identification (ID) in abstract information provided from the subnet managers 200 and stored in the CNLB unit 140. The apparatus for load balancing of a content-centric network according to the present invention divides the entire network into the two or more subnets 300 to be managed considering local characteristics or service providers. Accordingly, a unique ID is given to distinguish each of the two or more divided subnets 300, and each subnet 300 is distinguished by the ID. Subnet state information is configured such that state information about subnets corresponding to each of the IDs is stored as abstract information. The subnet state information is not for showing specific state information about each node, but for abstracting a state of each subnet 300 to be stored and managed. In other words, the state of all subnets is divided according to a hierarchy, abstracted and managed. Subnet traffic information shows a degree of network traffic circulating in each of the subnets 300 and is managed in phases. In addition, regarding subnet content information, content information stored in each of the subnet managing units 200 is provided to be stored and managed. Regarding subnet content information, information about network node currently being serviced is not managed, and the abstract information such as a content list of each of the subnets is stored and managed.

FIG. 4 is a diagram illustrating a configuration of the subnet 300 of the apparatus for load balancing of a content-centric network according to an exemplary embodiment of the present invention.

Referring to FIG. 4, the subnet 300 according to the apparatus for load balancing of a content-centric network according to an exemplary embodiment of the present invention includes a plurality of subnet nodes 310 and is controlled and managed by the subnet managing units 200.

A plurality of subnet nodes 310 not only provide a connection through a network but also search for content, which is distributed in each network node out of necessity, and directly deliver the corresponding content. In other words, along with a networking service to connect between a server and a user, a function of searching for content stored directly in the subnet nodes 310 and directly delivering the found content is performed for delivering content concentrated on an existing content delivery network (CDN) or a data center. The subnet node 310 includes a plurality of server nodes, a plurality of transit nodes and a plurality of cache nodes which are divided according to functions. The server node may act as a server storing content, the transit node may provide a networking function of connecting networks, and the cache node may temporally store the content in an internal cache.

The subnet managing unit 200 collects and manages information about the nodes of each of the subnets 300, information about a network between the nodes and information about delivered content. In response to a user's request, the subnet managing unit 200 searches for an optimal server node for delivering content and connects an actual server node and a network node accessed by the user.

TABLE 2

| | | | | | | | |
|---|---|---|---|---|---|---|---|
| Node ID | Form of Node | IP | StreamingService | Multicast | Content | Traffic | Error |
| | (Server/Trasit/ | Address | Information | Streaming | Information | State | Alarm |
| | Cache) | | | Information | | Information | |

Following is a node management table stored in the subnet managing unit 200 according to an exemplary embodiment.

Referring to Table 2, the subnet managing unit 200 gives a unique ID to each of the subnet nodes 310, stores and manages the ID, and stores forms of the subnet nodes 310. The forms of the subnet nodes 310 include a server node, a transit node and a cache node. The server node is a node acting as a server having abundant content for content service from the beginning. The transit node is a service node providing only a network function, and the cache node is a node which has its own cache so that it may temporally store content on its own. The subnet node 310 is configured with an IP overlay network compatible with an existing network and has an IP address. Streaming service information shows whether a video service is providable, or whether the subnet node 310 is capable of a streaming function. VOD or a real-time video service is provided only in a node capable of a streaming service.

Multicast streaming information shows whether a node provides a multicast automation function to automatically convert content into a multicast stream for a real-time video service in an optimal condition. Content information is information about content which is providable by a node, and a node capable of delivering content may be distinguished using the content information. In addition, the content information may be used to determine whether real-time streaming of the corresponding content is available. Traffic state information shows the degree of node traffic load, and an error alarm indicates the occurrence of an error in a server or switch of the subnet node 310.

TABLE 3

| | | | | |
|---|---|---|---|---|
| Flow ID | Flow Start | Flow End node | Flow Path | Content |
| | Node | | Information | Information |

Following is a flow table stored in the subnet managing unit 200 according to an exemplary embodiment.

Referring to Table 3, the flow table stored in the subnet managing unit 200 according an exemplary embodiment of the present invention is a flow of content service currently being provided on the subnet 300. On a network where the apparatus of load balancing of a content-centric network is applied, flow information currently being provided is used to optimally use network resources. Information about each flow is stored in the flow table. Each flow is given an ID to be distinguishable. In addition, the flow start node is a node starting to deliver a predetermined content on the subnet 300, and the flow end node is a node ending the delivery of a predetermined content on the subnet 300 and is the same as a node accessed by a user. The flow path information is information about a path through which content is moved from the flow start node to flow end node, and the content information is information about content delivered by the corresponding flow.

For example, suppose that a user is receiving a content service from a server node acting as a server out of arbitrary subnet nodes 310 of the subnet 300 and that another adjacent user wishes to receive the same content service. In this case, if the other adjacent user is to receive the content from the same server node of the subnet 300, a traffic flow needs to be generated for the other adjacent user requesting the content from the server node so that network resources may be redundantly used and wasted. To reduce such waste, the flow currently being serviced may be analyzed to find out a flow path on which the same content is being delivered so that the content may be delivered from the most adjacent node. In particular, a real-time streaming service may be provided if one of the server nodes capable of a multicast function on the flow path is selected to thereby newly generate a multicast service session.

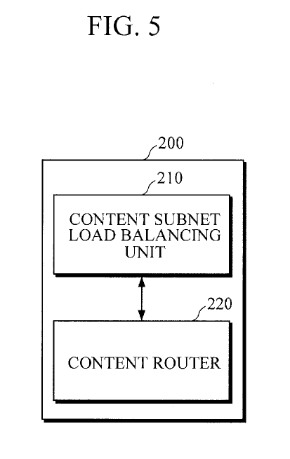

FIG. 5 is a diagram illustrating in detail the subnet managing unit 200 of the apparatus shown in FIG. 1.

Referring to FIG. 5, the subnet managing unit 200 includes a Content Subnet Load Balancing (CSLB) unit 210 and a content router 220. The CSLB unit 210 selects an optimal server node from among a plurality of nodes of the subnet 200 which are selected by the network managing unit and capable of delivering content requested by a user. The content router 200 connects between the server node and an access node of the subnet 300 accessed by a user.

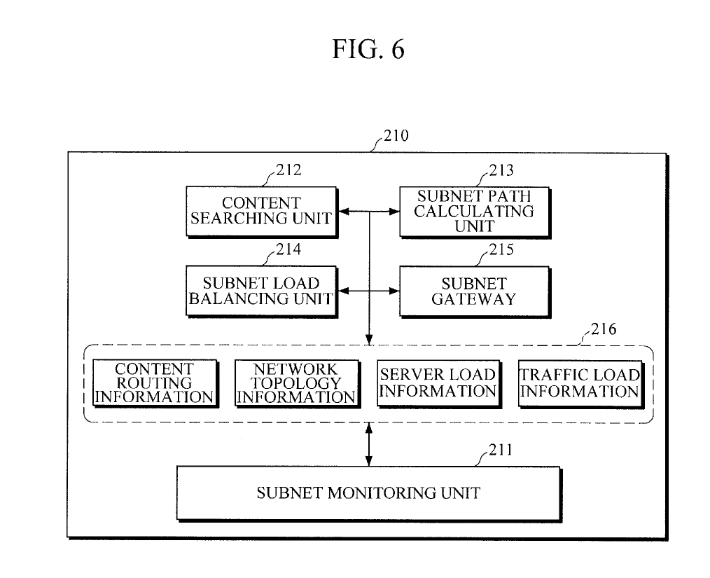

FIG. 6 is a diagram illustrating in detail the Content Subnet Load Balancing unit (CSLB) unit 210 of the subnet managing unit 200 shown in FIG. 5.

Referring to FIGS. 5 and 6, the CSLB 210 of the subnet managing unit 200 of the apparatus for load balancing of a content-centric network according to an exemplary embodiment of the present invention includes a subnet monitoring unit 211, a content searching unit 212, a subnet path calculating unit 213, a subnet load balancing unit 214, a subnet gateway 215 and a subnet information storage unit 216.

The subnet monitoring unit 211 collects information of network and topology belonging to the subnet 200. The information collected by the subnet monitoring unit 211 includes subnet node and network traffic load information, subnet network topology information of the subnet and content routing information.

According to a content request from a user, the content searching unit 212 determines whether the corresponding content exists using the information which is collected by the subnet monitoring unit 211 and stored in the subnet information storage unit 216. The subnet path calculating unit 213 calculates an optimal path between a subnet node of a subnet containing the content and a subnet node of a subnet accessed by a user. The subnet load balancing unit 214 selects an optimal subnet node taking into account of information collected by the subnet monitoring unit 211, the content search of the content searching unit 212 and path information obtained from the subnet calculating unit 213, and transmits information about the selected subnet node to the content router 220.

The subnet gateway 215 abstracts subnet information and transmits the subnet information to the SIG 141 of the CNLB unit 140 just in case that content requested by the user is not found on the corresponding subnet. The network managing unit 100 obtains abstract information about topology of the entire network and about the content based on the abstract information about the subnet 200 received from the subnet gateway 215.

The subnet information storage unit 216 stores information collected by the subnet monitoring unit 212 from the subnets, and the information includes content routing information, network topology information, server load information and traffic load information.

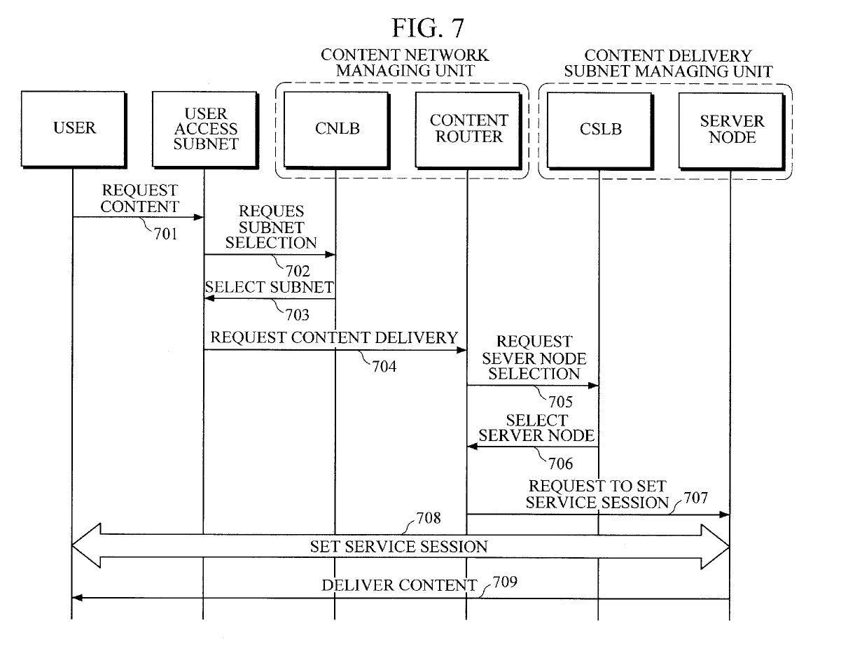

FIG. 7 is a flowchart illustrating a method for load balancing of a content-centric network according to an exemplary embodiment of the present invention.

Referring to FIG. 7, the method for load balancing of a content-centric network according to an exemplary embodiment of the present invention is, for a starter, receiving a content request from a user who currently accesses a network in 701. The user accesses a subnet determined among two or more subnets included in the network according to the current location or a service provider, selects content available to be delivered from the subnet, and requests the content.

According to the received content service request, selecting a subnet for delivering the content is requested in 702. In response to the received content service request, the subnet accessed by a user requests the CNLB unit of the content network managing unit to select a subnet for delivering the corresponding content.

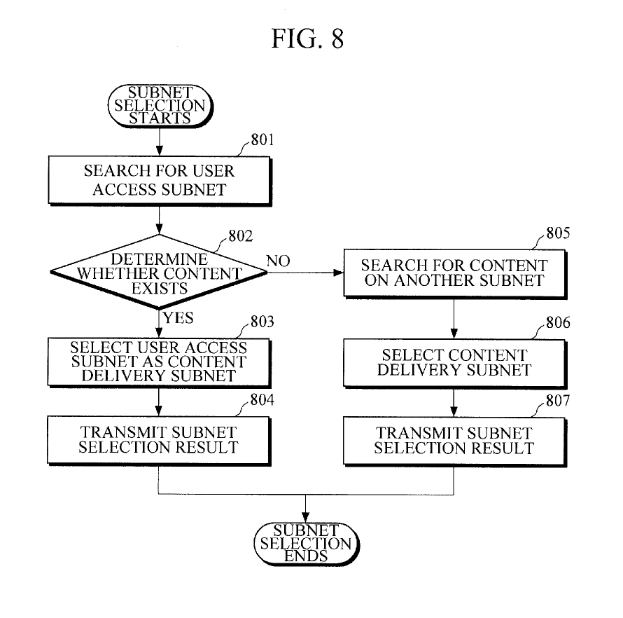

According to the received subnet selecting request, the subnet for delivering the content is selected in 703. In response to the request from a subnet accessed by a user, the CNLB unit searches for the subnet managing unit connected to the subnet accessed by the user so as to search for a subnet managing unit which has stored the content requested by the user or is currently delivering the content. The search is performed using the subnet abstract information collected and stored by each of the subnet managing units. If the corresponding content does not exist on the subnet accessed by the user, another subnet managing unit connected to a different subnet is searched. The corresponding content is searched using subnet abstract information collected by subnet gateways of each of the subnet managing units. In consideration of the current traffic, server and load state, delayed time and a physical distance, a subnet capable not only of providing a good-quality service but also of most efficiently providing network resources is selected from among subnets containing and delivering the corresponding content. The method for selecting the subnet will be explained in detail with reference to FIG. 8. In addition, the content service request is delivered to a content router in 704.

Then, the searched subnet managing unit is requested to select a server node of the subnet for delivering the content in 705. The subnet managing unit searched by the content network managing unit selects a server node for delivering the corresponding content through the CSLB unit in 706. According to a request from the content network managing unit, the CSLB unit selects the server node capable not only of delivering a good-quality service for a provider but also of most efficiently using network resources using stored abstract subnet information.

Then, setting a service session for delivering the content is requested in 707. A request for the service session for delivering the content from the selected server node to the user is delivered to the selected server node. The selected server node sets the service session for delivering the content in 708. The selected server node connects between the selected server node and a node accessed by the user so as to set the service session for delivering the content. In addition, the content is delivered through the set service session 709.

FIG. 8 is a flow chart illustrating a method for selecting a subnet in the method for load balancing of a content-centric network according to an exemplary embodiment of the present invention.

Referring to FIG. 8, the method for selecting a subnet in the method for load balancing of a content-centric network according to an exemplary embodiment is, for a starter, searching for content requested by a user from a subnet accessed by the user in 801. The user accesses one of arbitrary subnets so as to request a desired content from a network. The CNLB unit of the content network managing unit searches for information about each of the subnet managing units so as to find out a subnet containing the content requested by the user. The first step of searching for the subnet is determining whether the subnet accessed by the user has the corresponding content in 802. Using information stored in the subnet managing unit, the CNLB determines in advance whether the corresponding content exists on the subnet accessed by the user. If the content exists on the subnet accessed by the user, the content may be delivered to the user without searching for another subnet.

If the subnet accessed by the user has the corresponding content, the subnet accessed by the user is selected as a subnet delivering the content in 803. If the subnet accessed by the user has the corresponding content, it is not necessary to search for another subnet. Even if the same content exists on another subnet, the content is necessarily delivered through the subnet accessed by the user so that receiving the content from another subnet leads to network resource waste.

Then, the subnet selection result of the subnet accessed by the user is delivered in 804. If the CNLB selects the subnet accessed by the user as a content delivery subnet, a subnet managing unit connected to the corresponding subnet notifies the content network managing unit of an ID of the subnet accessed by the user, and the content network managing unit notifies the content router of the subnet managing unit connected to the subnet accessed by the user of information about the corresponding content and a user IP address, and requests for a server connection.

If the subnet accessed by the user does not have the corresponding content, another subnet managing unit searches for information about the corresponding content in 805. If the subnet accessed by the user does not have the corresponding content, the corresponding content is searched on all of the other subnet managing units included in the entire network. According to the search result, a subnet capable of delivering an optimal service is selected from among subnets containing the corresponding content as a content delivery subnet in 806. According to the search result, a plurality of subnets, rather than one subnet, containing the corresponding content may be found. In this case, a subnet which is capable of most efficiently delivering the content to a user needs to be selected from among a plurality of subnets containing the content. The CNLB unit selects an optimal subnet, considering a subnet state, a subnet load degree and a traffic load degree based on abstract information which is about each of the subnets and stored in the subnet managing units. Then, the result that the subnet has been selected from among the subnets containing the content is delivered in 807. If the CNLB selects the subnet having the highest efficiency from among a plurality of subnets containing the corresponding content, the corresponding subnet managing unit notifies the content network managing unit of an ID of the selected subnet, and the content network managing unit notifies a content router of the selected subnet of information about the corresponding content and a user IP address, and requests for a server connection.

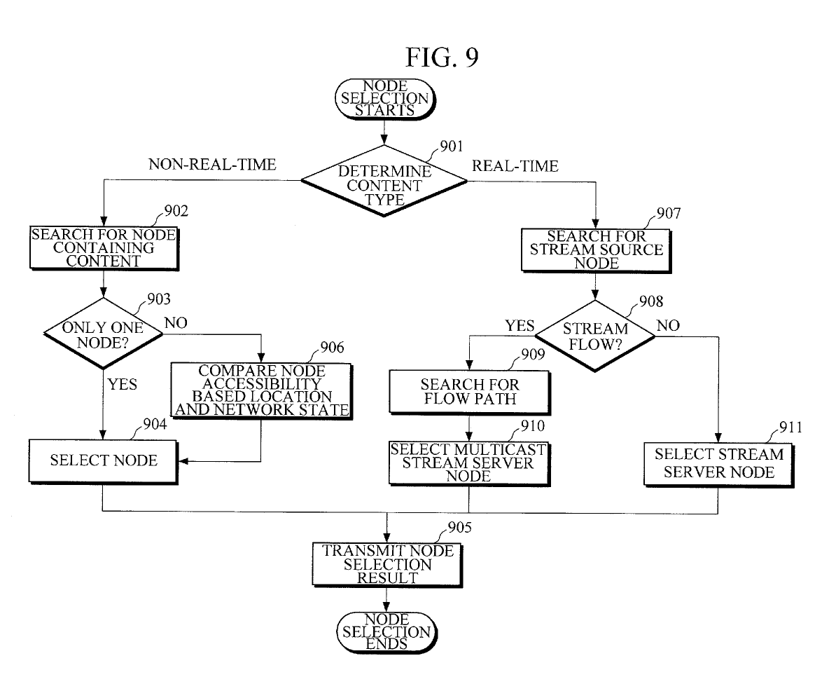

FIG. 9 is a flow chart illustrating a method for selecting a server node in the method for load balancing of a content-centric network according to an exemplary embodiment of the present invention.

Referring to FIG. 9, the method for selecting a server node in the method for load balancing of a content-centric network according to an exemplary embodiment is, for a starter, determining a type of content requested by a user in 901. The type of the corresponding content may be determined using content information. If the corresponding content is unicast like VOD, a node is searched using node information table.

If the type of the corresponding content is non-real-time, a node containing the corresponding content is searched in 902. A Content Subnet Load Balancing (CSLB) unit uses a node information table and a flow table collected by a subnet monitoring unit in order to find a node capable of delivering the requested content. Using the node information table, any node containing the corresponding content and currently capable of service is searched and a connection between the found node and a user access node is determined.

Then, it is determined whether only one node is found in 903. Only one node or a plurality of nodes capable of storing and delivering the corresponding content may be found using the node information table.

If it is determined that only one node is capable of delivering the corresponding content according to the search result, the found node is selected as a content delivering node in 904. In addition, the node selection result and information about the selected node are transmitted to a content network managing unit in 905.

If it is determined that a plurality of nodes are capable of delivering the corresponding content according to the search report, node accessibilities are compared based on locations and network states in 906. If a subnet has one or more nodes which have stored the content and are available to deliver the content, costs for connecting a network between the corresponding server nodes and a user access node is calculated to thereby select an optimal server node. At this time, the selected node may be a server node which has initially stored the content or a cache node which temporally stores the content in the middle of content delivery. The node selection result that a node is selected according to node accessibility is transmitted to the content network managing unit.

If a type of the corresponding content is determined as real-time streaming according to the content type determination, a stream source node is searched in 907. If the corresponding content is not a unicast type and needs a real-time streaming service like a real-time broadcast, it is difficult to select an optimal node using only node information table. A real time stream service does not require content to be initially stored or temporally stored in a cache for reuse and is characterized by transmitting information continuously received in real-time from a predetermined source to a desired node.

It is determined whether the found source node has a stream flow of the corresponding content in 908. If the corresponding content is being streamed in the current source node, the stream flow of the corresponding content exists. The stream flow is delivered through a plurality of broadcast nodes to an arbitrary destination. If there is a broadcast node adjacent to a node currently accessed by the user among a plurality of broadcast nodes and the adjacent broadcast node is capable of an additional real-time streaming service, receiving a content streaming service from the broadcast node may be more efficient. To this end, if a real-time content request is received, a source node of the corresponding content is searched and extracted using the node information table.

If the stream flow of the corresponding content exists, a path of the corresponding stream flow is searched in 909. The stream flow delivers the content via a plurality of broadcast nodes which are disposed between the source node and a node requesting for the corresponding content. As above, the path of the stream flow is searched to thereby search for pass-through broadcast nodes. A flow providing the corresponding content stream is searched in the flow table so as to extract information about the nodes through which the corresponding flow passes. In addition, a node which is adjacent to a node accessed by the user and capable of multicast streaming is selected from a plurality of the found broadcast nodes in 910. If a broadcast node through which the stream flow of the corresponding content passes is adjacent to the node accessed by the user, it may be more efficient to receive a streaming service from the broadcast nodes. Hence, from among the broadcast nodes capable of multicast streaming for providing further streaming service for the user access node, a superior broadcast node rather than a source node delivering the content in terms of accessibility and traffic is chosen as a multicast stream server node. If the broadcast node is selected, the selection result of the selected node is transmitted to the content network managing unit.

If the stream flow of the corresponding content does not exist, the source node capable of delivering the corresponding content is selected as a stream server node in 911. In addition, the selection result of the selected stream server node is transmitted to the network managing unit 905.

The method and the apparatus for load balancing of a content-centric network according to an exemplary embodiment of the present invention may enhance traffic efficiency as an optimal server node is selected on a network in the middle of content delivery from a content server to a user. In addition, a flow of real-time stream is analyzed to select a multicast node to thereby improve real-time traffic transmission efficiency so that a real-time streaming service with high quality may be provided. In addition, an optimal subnet may be selected using abstract subnet information and a cache or a storage server may be designated on a client subnet to provide content at a request for the same content so that it may realize a structure where different areas or service providers can be associated with each other.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for load balancing of a content-centric network receiving a content request from a user, the apparatus comprising:
a content network managing unit configured to divide the content-centric network into two or more subnets according to physical distance or service providers, to store received subnet information, to select a subnet delivering content requested by the user based on the received subnet information and to deliver the selection result, and
two or more subnet managing units configured to collect and manage the subnet information including a plurality of subnet nodes of the two or more subnets, information about a network between the plurality of subnet nodes of the two or more subnets and information about delivered content, to deliver the subnet information to the content network managing unit, to search for the plurality of subnet nodes for delivering the content and to select a subnet node delivering the requested content from among the plurality of subnet nodes.

2. The apparatus of claim 1, wherein a plurality of content stored in one of the two or more subnets are different from each other without redundancy.

3. The apparatus of claim 2, wherein each of the two or more subnets is capable of redundantly storing the same content.

4. The apparatus of claim 1, wherein the content network managing unit is configured to receive the subnet information from the two or more subnet managing units, to abstract the received subnet information and to store the abstract subnet information.

5. The apparatus of claim 4, wherein the abstract subnet information comprises at least one of subnet identifications (ID) for distinguishing the two or more subnets from each other, subnet state information for showing a network state of each of the two or more subnets, subnet traffic information for showing a degree of network traffic circulating in each of the two or more subnets and subnet content information for showing information about content stored in each of the two or more subnets.

6. The apparatus of claim 1, wherein the plurality of subnet nodes of the two or more subnets connect between the two or more subnets or between nodes included in the two or more subnets and are capable of storing and delivering the plurality of content.

7. The apparatus of claim 6, the plurality of subnet nodes further comprising:
a plurality of server nodes configured to store the plurality of content so as to act as a server;
a plurality of cache nodes configured to temporally store the plurality of content; and
a plurality of transit nodes configured to connect between the plurality of subnet nodes.

8. The apparatus of claim 1, wherein, in response to two or more content being found, the two or more subnet managing units select one node from two or more nodes containing the found content based on a network state to thereby deliver the found content.

9. The apparatus of claim 1, wherein when a real-time streaming method is necessary for the requested content, the two or more subnet managing units deliver the requested content using the real-time streaming method.

10. The apparatus of claim 9, wherein, in order to deliver the real time streaming content, the two or more subnet managing units selects a source node delivering the real-time streaming content or a superior node in terms of accessibility and traffic from among a plurality of broadcast nodes existing on a flow path of a stream flow of the real-time streaming content.

11. The apparatus of claim 1, wherein the two or more subnet managing units collect information about the plurality of subnet nodes of the two or more subnets and the plurality of content and select a node capable of delivering the content to the user based on the collected information.

12. A method for load balancing of a content-centric network comprising two or more subnets, the method comprising:
in response to a content request received from a user, searching for two or more subnets containing the requested content;
in response to two or more subnets being found according to the search result, selecting one subnet delivering the requested content from among the two or more found subnets according to a network state;
selecting a node delivering the requested content from among a plurality of nodes included in the selected subnet according to the network state; and
setting a session connection between the selected subnet and a subnet accessed by the user.

13. The method of claim 12, wherein the selecting of the one subnet delivering the requested content comprises
searching for the requested content on the subnet accessed by the user and
in response to the requested content being searched on the subnet accessed by the user, selecting the subnet accessed by the user as a content delivery subnet.

14. The method of claim 13, further comprising:
in response to the requested content not being found on the subnet accessed by the user, searching for the requested content on another subnet; and
in response to two or more subnets being found according to a search result for the requested content, selecting as the content delivering subnet a subnet having the highest accessibility from among the found two or more subnets in consideration of accessibility according to a network state.

15. The method of claim 12, wherein the selecting of the node delivering the requested content further comprises
determining whether the requested content is a non-real-time content,
in response to the requested content being a non-real-time content, searching for any node containing the requested content from among the plurality of nodes included in the selected subnet, and
in response to a plurality of nodes containing the requested content being found, selecting one node from among the plurality of found nodes according to node accessibility based on the network state.

16. The method of claim 15, further comprising:
in response to the requested content being a real-time content, searching for a source node capable of a streaming service for delivering the requested content;
determining whether the found source node has a stream flow of the requested content;
in response to the stream flow existing, searching for a flow path of the stream flow; and
selecting one of broadcast nodes existing on the flow path according to node accessibility based on the network state by comparing between a node capable of multicast stream and the source node.

17. The method of claim 16, further comprising:
in response to the stream flow not existing, selecting the found source node as a content providing node.

18. The method of claim 15, further comprising:
in response to only one node being found, selecting the found node as a content providing node.
